(19) United States
(12) Patent Application Publication
(10) Pub. No.: US 2026/0211683 A1
(43) Pub. Date: Jul. 23, 2026

(54) Universal Declarative Framework for Automating Data Pipelines

(71) Applicant: Schemon Inc., Markham (CA)

(72) Inventor: Gang Jin, Markham (CA)

(21) Appl. No.: 19/033,094

(22) Filed: Jan. 21, 2025

(51) Int. Cl. G06F 9/44; G06F 16/21; G06F 16/215; G06F 21/62

(52) U.S. Cl. CPC G06F 9/44; G06F 16/213; G06F 16/215; G06F 21/6245

(57) ABSTRACT

A declarative data processing system is disclosed that converts file specifications into logical data pipelines, enforces data quality rules, and deploys them to target platforms. A fields section defines data structures, while a configuration section prescribes actions such as extracting, transforming, and loading. Machine learning modules can optimize pipeline configuration, and both streaming and scheduled batch operations are supported. The system handles schema evolution, masking sensitive information, and generating audit reports for governance.

### FIELD OF THE INVENTION

The invention relates to the field of data engineering and, more specifically, to a declarative platform for automating data pipeline creation, optimization, and governance.

### BACKGROUND OF THE INVENTION

The following description includes information that may be useful in understanding the present invention. It is not an admission that any of the information provided herein is prior art or relevant to the presently claimed invention, or that any publication specifically or implicitly referenced is prior art.

In data engineering, the development and optimization of data pipelines often require significant manual effort and expertise. This process involves challenges such as managing diverse data sources, ensuring compatibility across platforms, handling transformation rules, and maintaining data quality and governance. Traditional approaches frequently rely on custom scripting or platform-specific tools, leading to inefficiencies, scalability issues, and difficulty in adapting to new requirements or technologies. Moreover, ensuring compliance with governance standards and integrating with existing workflows adds further complexity to the pipeline development process.

Existing solutions provide varying degrees of automation and capability, but they fall short in some aspects. For example, US Patent Publication No. 20160328566 to Nellamakkada appears to focus on extract-transform-load (ETL) processes but does not leverage automated configuration across diverse platforms. US Patent Publication No. 20220150121 to Gupta et al. provides platform-independent specifications for data center entities but does not apparently address generalized pipeline automation or integration with transformation rules and data quality. US Patent Publication No. 20210035116 to Berrington et al. refers to data governance but appears to lack discussion of dynamic and vendor-agnostic data pipeline. US Patent Publication No. 20220164452 to Landman discloses digital signatures and securing infrastructure but does not apparently incorporate declarative metadata-driven automation for pipeline management.

The limitations of these and other prior art references demonstrate the need for a universal, declarative platform that aims to simplify and automate the creation and management of data pipelines while addressing data quality and governance in a universal, or vendor-agnostic manner. Such a platform would not only mitigate manual effort but also enhance flexibility, scalability, and compliance.

Thus, there is a need for a universal, declarative platform that allows for the creation and management of data pipelines while addressing data quality and governance issues to mitigate some of the challenges mentioned above, and to provide an alternative implementation to prior systems.

### BRIEF DESCRIPTION OF DRAWINGS

Various objects, features, aspects, and advantages of the inventive subject matter will become more apparent from the following detailed description of preferred embodiments, along with the accompanying drawing figures in which like numerals represent like components.

FIG. 1 is a block diagram of a system architecture for a universal declarative platform, in accordance with an example of the present specification.

FIG. 2 is a block diagram illustrating a method of creating and deploying a data pipeline, in accordance with an example of the present specification.

FIG. 3 is a block diagram showing the data pipeline subsystem for advanced ingestion and transformations, in accordance with an example of the present specification.

FIG. 4 is a block diagram demonstrating how declarative inputs, automation, and machine learning components interoperate to facilitate data-driven workflows, in accordance with an example of the present specification.

### DETAILED DESCRIPTION OF THE INVENTION

This detailed description provides an explanation of the embodiments of the present specification. The present specification encompasses a variety of systems, methods, and non-transitory computer-readable media. In accordance with the present invention, a platform architecture is disclosed that employs declarative specifications to manage data ingestion, transformation, and governance processes. By combining automation components, quality controls, and machine learning-based optimizations, the platform streamlines how diverse data workloads are defined, executed, and monitored. This results in a scalable, flexible framework capable of adapting to evolving business requirements and integrating with various on-premises or cloud environments.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of features used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed considering the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

A computer system may include one or more processors, memory, and storage devices configured with software and/or firmware to implement the specialized functionalities described herein. Such hardware is designed to support the computational demands of a declarative data platform that leverages machine learning algorithms (e.g., neural networks, decision trees, or support vector machines) for automated data ingestion, transformation, and governance tasks.

In particular, the system processes data through a multi-stage pipeline encompassing collection, cleaning, normalization, and analysis. Machine learning components within the platform can analyze large datasets to identify relationships, detect anomalies, and make predictive insights, thereby streamlining data workflows and enhancing data-driven decision making.

Training of machine learning models involves feeding domain-specific datasets into the system, where these data points iteratively adjust model parameters until a target accuracy or performance criterion is met. Depending on the intended application—be it anomaly detection, predictive analytics, or recommendation systems—the invention can utilize supervised, unsupervised, or reinforcement learning approaches.

To facilitate user engagement, the system includes a front-end interface (e.g., web-based, desktop, or mobile application) that enables the configuration of declarative specifications, visualization of analysis results, and interactive adjustment of operational parameters. This design allows users to integrate and manage data processes without extensive coding.

The system can be deployed on cloud-based infrastructures that provide scalable computing and storage capabilities for large-scale data processing needs. Distributed networking technologies further enable the platform to integrate with remote data sources, coordinate with external systems, and deliver results to geographically dispersed users.

One or more computers may be configured to perform these described operations by virtue of having installed software, firmware, hardware, or any suitable combination thereof. Executable instructions within computer programs run on data processing apparatuses that, in turn, carry out the sequence of operations specified by the declarative platform, ensuring consistent, automated handling of data-driven tasks.

As used herein, the term “declarative” or “declaration file” is intended to extend to any typically high-level specification, instruction, or configuration that describes desired outcomes, constraints, or goals. Declarative inputs may include schemas, rules, or policies formulated in a manner that an underlying system can interpret and automate, abstracting complexity from the end user. Declarative files may be expressed in formats such as YAML (Yet Another Markup Language), JSON (JavaScript Object Notation), XML (Extensible Markup Language), or any syntactically compatible variant thereof, including extensions, subsets, or hybrids of these formats. For example, YAML may be used to define hierarchical relationships and configurations in a simplified text-based structure, while JSON and XML may represent the same information in serialized or nested formats suitable for interoperability across diverse systems. The term “declarative” also encompasses custom formats that adhere to the principles of abstracting implementation details, provided they maintain a structure interpretable by the system's processing modules. This definition includes variations in syntax, annotations, or extensions added for specific domain requirements, as well as non-standard adaptations of YAML, JSON, or XML that remain functionally equivalent for describing data processing, governance, or transformation workflows. As will be discussed below, these declarations are converted into “intermediate representations,” which are platform-agnostic logical constructs that abstract and encapsulate the specified instructions, ensuring portability and compatibility across diverse execution environments.

The term “platform” extends to any integrated computing environment (whether on-premises, cloud-based, or hybrid) that provides application services, data processing capabilities, and user-facing interfaces. A platform may comprise hardware, software, firmware, or any combination thereof, and may be distributed across multiple physical or virtual systems.

“Data governance” encompasses policies, procedures, and mechanisms for managing data integrity, security, accessibility, and compliance. Data governance may include defining user permissions, ownership responsibilities, data lineage tracking, retention policies, or any controls necessary to ensure proper handling of data assets throughout their lifecycle.

“Data ownership” refers to a formal or de facto allocation of responsibility, authority, or custodianship over specific data assets or data products. Owners may define access policies, set quality standards, or exercise rights to modify data structures in accordance with established governance rules. These governance rules, referred to herein as “declarative governance rules,” are policies that ensure consistent enforcement of data security, accessibility, and compliance standards across the platform. Declarative governance rules may specify actions such as masking sensitive information (e.g., personally identifiable information), restricting access to authorized users based on predefined roles or permissions, and generating detailed audit trails that log all access or modifications to data. By using declarative specifications, these governance rules abstract the complexity of implementation while maintaining flexibility and adaptability, allowing data owners to manage compliance, security, and stewardship effectively throughout the data lifecycle.

“Data product” is any definable entity or output constructed from one or more data sources, transformations, or analytics processes. A data product may include tables, streams, composite views, or other data artifacts, along with any associated metadata, quality requirements, or lineage information. Metadata provides descriptive, structural, and administrative information about data. According to one example, metadata describes data attributes such as field types, formats, and relationships and captures lineage, detailing the origins, transformations, and dependencies of data assets, which can be used for traceability and error resolution. Ownership metadata identifies custodians and their responsibilities, while quality metadata records compliance with accuracy, completeness, and reliability standards.

As used herein, the term “data quality” is intended to encompass the degree to which data meets defined accuracy, completeness, consistency, reliability, or other relevant standards. Quality checks may be enforced using rules-based validation, machine learning, or external tools, ensuring data is trustworthy and fit for its intended use.

“Machine learning” is intended to include any algorithmic or computational technique that enables a system to learn from and adapt to data, examples of which may include neural networks, decision trees, clustering algorithms, or reinforcement learning. Such techniques may be employed for tasks such as optimization, anomaly detection, or predictive analytics within the invention.

The term “data pipeline” is intended to extend to any sequence or network of processes involved in collecting, transforming, transporting, or analyzing data. This may involve batch processing, micro-batch processing, streaming ingestion, or other operational modes and can be orchestrated by software, hardware, or a combination thereof. Batch processing refers to the execution of data workflows in large, discrete chunks, typically at scheduled intervals (e.g., nightly or hourly). It is suited for use cases requiring high-volume data processing, such as consolidating transactional records or generating periodic reports. Micro-batch processing operates on smaller chunks of data at more frequent intervals, bridging the gap between batch and streaming modes. This approach is ideal for scenarios where near-real-time updates are necessary, such as processing sensor readings or monitoring incremental database changes. In contrast, streaming ingestion processes data continuously as it arrives, offering real-time or near-real-time insights. This mode is essential for time-sensitive applications like financial market analysis, fraud detection, or Internet of Things (IoT) telemetry. By supporting these execution modes, data pipelines can adapt to different data velocity and processing requirements, ensuring timely, efficient, and scalable data workflows.

As used herein, the term “user interface” is intended to include any front-end application, portal, or interactive element (web-based, desktop, mobile, or otherwise) that permits a user to configure system parameters, declare requirements, visualize outputs, or manage system operations. According to some examples, the interface may be graphical, textual, or voice-based.

A declarative data processing system is disclosed that converts file specifications into logical data pipelines, enforces data quality rules, and deploys them to target platforms. A fields section defines data structures, while a configuration section prescribes actions such as extracting, transforming, and loading. Machine learning modules can optimize pipeline configuration, and both streaming and scheduled batch operations are supported. The system handles schema evolution, masking sensitive information, and generating audit reports for governance.

In one exemplary embodiment, Table 1 (“Simple YAML Example”) illustrates how a declarative specification can be employed to define a new data table, configure its fields, and optionally apply transformations. In this simplified use case, the table is titled employee_table and includes a primary column named Name. The example further demonstrates how additional metadata columns (SourcePath and SourceModifiedAt) may be appended through the [transformation_config] section, thus yielding a final table structure of three columns. Moreover, this declarative YAML snippet shows how certain governance-oriented properties (e.g., ownership, data quality requirements) can be declared alongside general configuration details (e.g., file naming conventions, SQL-based merge operations). By defining what columns the table contains and how it should be populated, the example underscores the declarative paradigm's ability to abstract away implementation details while allowing for optional extensions—such as custom SQL logic—to meet varied data processing needs.

Still with reference to Table 1, lines 1-4 declare the processing stage and ownership parameters, which specify the operational environment and responsible user. Lines 5-7 define the entity as employee_table, providing a short description of its intended purpose. Lines 14-19 configure the Name field, marking it as required, non-nullable, and referencing a basic string type. Lines 23-25 demonstrate a governance rule that rejects data if the first value in the Name column does not match a specified string. In lines 34-48, the snippet appends two metadata columns—SourcePath and SourceModifiedAt—via the [transformation_config] section, thus expanding the final table structure to three columns. Finally, lines 50-55 define an optional SQL-based merge logic, enabling domain-specific transformations or insert-update operations.

The resulting output of these transformations is illustrated in Table 2, which provides an example of the processed data, showing how the declarative specifications translate into the final pipeline-generated table.

By enabling users to define what data must look like, how it should be transformed, and under which rules or governance standards it must operate, the specification coordinates multiple system components in a single, human-readable file. This harmonization reduces the need for extensive custom scripting, while simultaneously allowing for powerful metadata handling, real-time validations, and flexible integration points (such as custom SQL merges). Through this paradigm, organizations can automate large segments of their data workflows, achieve rapid time-to-insight, and adapt to the ever-evolving landscape of enterprise data requirements.

TABLE 1
Simple YAML Example

| | |
|---|---|
| 01 | stage: stage |
| 02 | owner: |
| 03 | name: Brian |
| 04 | email: brian@schemon.io |
| 05 | entity: |
| 06 | name: employee_table |
| 07 | description: A table of employee names. |
| 08 | platform: rds sql server |
| 09 | format: native |
| 10 | type: table |
| 11 | tasks: |
| 12 | - name: source_to_stage_employee_table |
| 13 | fields: |
| 14 | - name: Name |
| 15 | type: string |
| 16 | required: true |
| 17 | nullable: false |
| 18 | unique: false |
| 19 | description: An example name. |
| 20 | expectations: |
| 21 | platform: schemon |
| 22 | rules: |
| 23 | - rule: First(Name) = ″John″ |
| 24 | description: Checking if the first value in the column ″Name″ is ″John″. |
| 25 | action: reject |
| 26 | config: |
| 27 | file_name_config: |
| 28 | pattern: ″employee_table″ |
| 29 | extension: csv |
| 30 | case_sensitive: false |
| 31 | transformation_config: |
| 32 | truncate: true |
| 33 | append_config: |
| 34 | - name: SourcePath |
| 35 | type: string |
| 36 | required: true |
| 37 | nullable: false |
| 38 | unique: false |
| 39 | merge_key: true |
| 40 | pd_default: metadata.full_path |
| 41 | description: The source file path |
| 42 | - name: SourceModifiedAt |
| 43 | type: string |
| 44 | required: true |
| 45 | nullable: false |
| 46 | unique: false |
| 47 | pd_default: metadata.modified |
| 48 | description: When the source file was modified |
| 49 | # optional merge operation (SQL) |
| 50 | sql_config: |
| 51 | merge_into: \| |
| 52 | SELECT Name |
| 53 | ,'s3://test_bucket/employee_table.csv' AS SourcePath |
| 54 | ,'2024-09-01' AS SourceModifiedAt |
| 55 | FROM TempViewOfSourceFile |

TABLE 2
Generated SQL Table (employee_table in RDS SQL Server):

| Name | SourcePath | SourceModifiedAt |
|---|---|---|
| John Doe | s3://bucket/employee.csv | 2024 Sep. 1 |

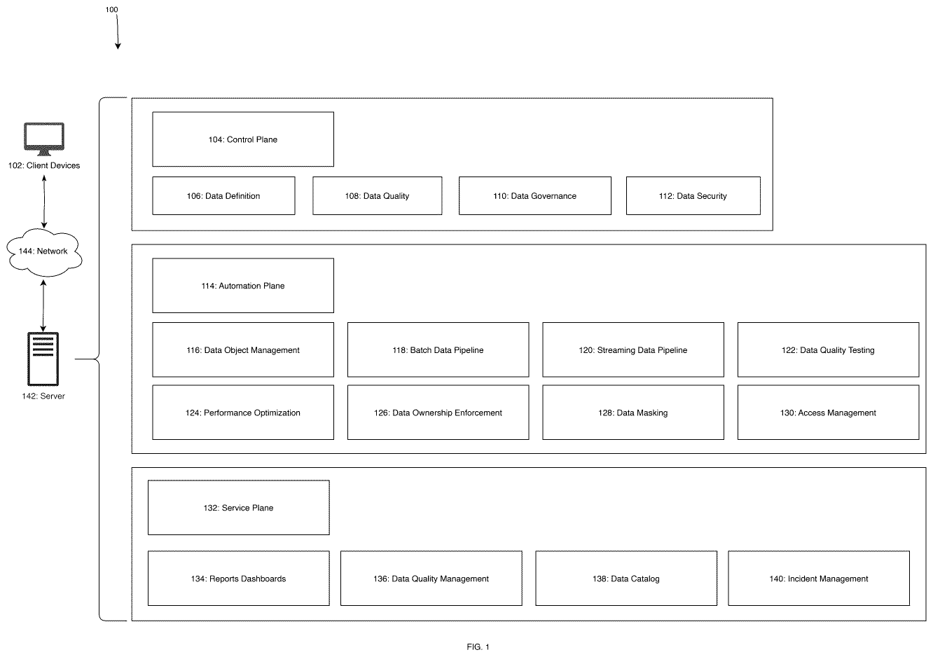

Referring now to FIG. 1, a block diagram illustrates an exemplary system 100, hereinafter referred to as a universal declarative platform. In the depicted embodiment, client devices 102 connect via a network 144 to a server 142 that hosts the core functionality of system 100. Server 142 encompasses multiple planes and sub-components, each of which addresses discrete aspects of declarative data processing, governance, and monitoring.

Within this environment, control plane 104 provides orchestration of data-centric operations. It maintains data definition 106 (managing schemas and entity constraints), data quality 108 (validating and assessing data reliability), data governance 110 (overseeing compliance, permissions, and stewardship policies), and data security 112 (handling data protection via encryption, tokenization, or masking). Meanwhile, an automation plane 114 streamlines data workflows, from data object management 116 (creating and updating files or streams) to batch data pipeline 118 and streaming data pipeline 120 (facilitating either scheduled or real-time data processing), data quality testing 122 (checking for anomalies), performance optimization 124 (enhancing resource usage), data ownership enforcement 126 (ensuring correct stakeholder privileges), data masking 128 (preserving privacy), and access management 130 (controlling entitlements). Finally, a service plane 132 offers external-facing services such as reports dashboards 134, data quality management 136, data catalog 138, and incident management 140, allowing users to visualize, audit, search, and resolve data-related activities.

In certain embodiments, the system employs a push architecture as a mechanism for actively transmitting metadata or data structures to external systems, such as data catalog 138. Unlike traditional pull-based approaches, where external systems query or fetch data on demand, a push architecture ensures metadata is proactively delivered whenever it is updated, facilitating synchronization, governance, and data discovery.

By dividing tasks across these distinct planes, system 100 supports a declarative model that leverages automated pipeline creation, comprehensive governance, and ongoing monitoring. For instance, a user at client device 102 might draft a YAML specification describing table structures, data quality rules, or transformation logic. According to one example, “transformation logic” refers to a set of operations or rules that dictate how raw data is manipulated into the desired format or structure. This can include filtering, aggregating, joining, or converting data to meet the requirements defined in the declarative specification.

Upon receipt by the server 142 (over network 144), the platform applies components like data definition 106 or data quality 108, organizes processing via batch data pipeline 118 or streaming data pipeline 120, and finally audits results using service plane 132 capabilities. If any of the user-defined configurations reference advanced logic—such as those shown in Table 1—the system automatically orchestrates these steps, thereby ensuring more consistent, policy-compliant data flows. This architecture enables organizations to handle evolving data requirements while adhering to robust governance and security standards.

In certain embodiments, system 100 may be used to define and execute data pipelines in a declarative fashion. For instance, one might supply a YAML-based specification (similar to Table 1) identifying which data objects to create, how to structure fields, and which quality or governance rules to enforce. After receiving these directives over network 144, the server 142 leverages the automation plane 114 to parse, validate, and orchestrate the requested tasks. The system then employs data definition 106 and data quality 108 to confirm that input schemas and quality constraints comply with declared standards. Meanwhile, data governance 110 and data security 112 verify user permissions, access entitlements, and data protection policies.

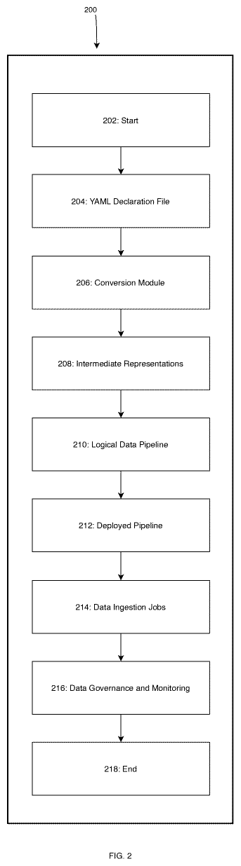

Referring now to FIG. 2, a flow diagram illustrates an example sequence of operations 200 within system 100, beginning at Start 202. Upon initialization, a user or automated process provides a declaration file 204, which can be a YAML (yet another markup language) declaration file, which describes the structural and operational requirements for data ingestion, transformation, and governance. This file is processed by a conversion module 206, translating the text-based configuration into standardized instructions. Drawing parallels with the discussion of FIG. 1, these instructions then populate intermediate representations 208, enabling the platform to remain infrastructure-agnostic. The term “intermediate representations” refers to data structures or logical constructs that abstract the declarative specifications into a platform-agnostic format. These representations serve as the foundation for generating data pipelines and facilitate adaptation across heterogeneous environments.

Still with reference to FIG. 2, once verified, the definitions flow into a logical data pipeline 210, specifying how data shall be ingested, validated, and delivered to subsequent modules. This pipeline is then materialized as a deployed pipeline 212, wherein real or simulated data is processed according to the declared logic. At data ingestion Jobs 214, the system applies relevant transformations and validations in accordance with user-defined constraints-potentially involving quality rules analogous to those in data quality 108. During this operational phase, data governance and monitoring 216 continuously checks for compliance, logging anomalies and verifying datasets. Ultimately, end 218 indicates completion of pipeline activities or a transition to a steady operational mode, awaiting further instructions (which may again be declared in a format akin to Table 1).

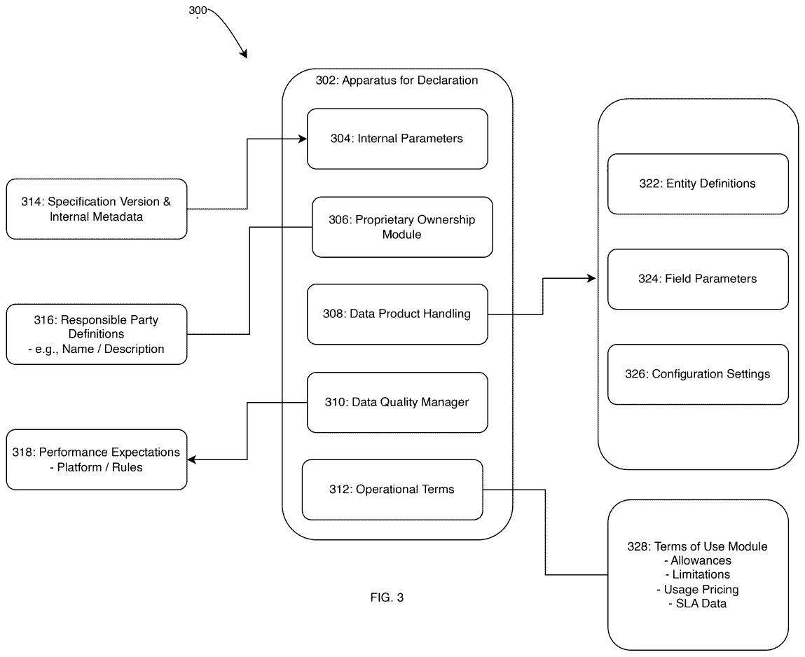

Referring now to FIG. 3, a block diagram depicts a data pipeline subsystem (collectively referred to as system 300) for interpreting declarative specifications, converting them into executable instructions, and coordinating deployment alongside governance measures. Initially, a declaration file 142 captures the structural, quality, and operational requirements for data tasks. The conversion module 144 then translates these requirements into intermediate representations 146, preserving logical relationships and rules in a platform-neutral format. Subsequently, the logical data pipeline 148 consolidates these representations into an actionable flow-encompassing entity creation, field definitions, and optional transformations. Following any necessary validations, the flow is deployed as a deployed pipeline 150 onto the relevant execution infrastructure (e.g., on-premises or cloud-based).

In practical operation, data ingestion jobs 152 retrieve data from specified sources at predetermined intervals or event triggers, applying transformations and validations declared in the declaration file 142. Throughout these workflows, data governance and monitoring 154 enforces ownership, security, and compliance rules, logging all pertinent activities. For instance, if the declaration file 142 references a requirement similar to data ownership enforcement 126 or a rule to reject anomalous values as described under data quality 108 (see FIG. 1), this subsystem ensures they are upheld. As a result, system 300 maintains a flexible, extensible environment capable of adapting to new data assets or evolving compliance demands.

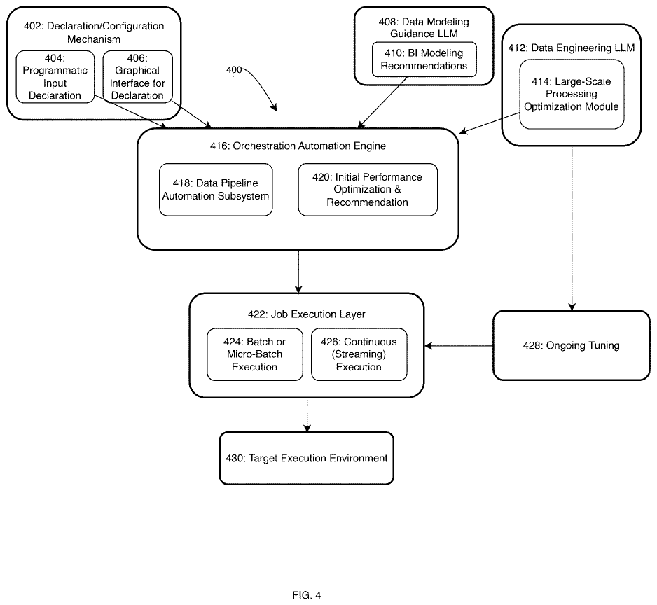

Referring now to FIG. 4, a block diagram presents an exemplary system 400 illustrating how declarative inputs, automated orchestration, and machine learning components collaborate to enable data-driven workflows. A declaration/configuration mechanism 402 provides a high-level interface for specifying ownership (e.g., defining data product custodians), data product structure (e.g., naming fields, specifying SQL logic), and optional data quality demands (which may rely on an internal quality engine or integrations with external solutions).

In this embodiment, programmatic input declaration 404 and graphical interface for declaration 406 each feed into two specialized large language models (LLMs)-namely, the data modeling guidance LLM 408 (generating bi modeling recommendations 410) and the data engineering LLM 412 (advising on large-scale optimization via large-scale processing optimization module 414). LLMs refer to advanced machine learning models trained on extensive corpora of structured and unstructured text data, enabling them to process and interpret declarative inputs effectively. These models analyze specifications provided in formats such as YAML, JSON, or XML to extract semantic meaning, identify dependencies, and propose actionable improvements. Specifically, the data modeling guidance LLM 408 evaluates schema and field definitions to ensure alignment with industry standards and best practices for data architecture. In parallel, the data engineering LLM 412 focuses on the operational aspects of pipeline execution, providing optimization suggestions for resource utilization, scheduling, and scaling.

Generally speaking, LLMs can serve as an adaptive layer within the system, transforming user-defined declarations into optimized configurations, thereby improving pipeline performance and ensuring compliance with declared goals and constraints.

An orchestration automation engine 416 consolidates these inputs and recommendations into instructions managed by a data pipeline automation subsystem 418 and an initial performance optimization & recommendation 420 routine. The output proceeds to a job execution layer 422 that can handle batch or micro-batch execution 424 or continuous (streaming) execution 426, with an ongoing tuning mechanism 428 further calibrating performance based on real-time metrics. Ultimately, the resulting jobs deploy to a target execution environment 430, which may be an on-premises cluster, a managed cloud platform, or any suitable infrastructure. This architecture, exemplified by the declarative patterns found in Table 1, provides an extensible framework for scalable data pipelines, with governance features scheduled for phased enhancement.

In one aspect, the invention provides a method comprising the steps of receiving a declaration file that includes a fields section defining a database table and a configuration section specifying data processing actions on that table. The method further includes converting the declaration file into logical representations (e.g., intermediate representations) that enforce data quality rules. Using the configuration section and those representations, the invention generates a data pipeline that extracts, transforms, and loads data into the database table, subsequently deploying this pipeline to a data processing platform for ingestion. The invention then receives one or more jobs or workflows for execution against the generated pipeline and proceeds to execute them.

In another aspect, the invention provides a system for declarative data processing, comprising a memory and a processor configured to perform steps including: receiving the declaration file, converting it into intermediate representations that enforce data quality, generating and deploying a data pipeline, and executing jobs or workflows thereon.

In yet another aspect, the invention provides at least one non-transitory computer-readable storage medium storing instructions which, when executed by a processor, cause the processor to receive a declaration file having a fields section and configuration section, convert the file into logical representations enforcing data quality, generate and deploy a data pipeline based on said file, and execute one or more workflows against the generated pipeline.

Implementations may include one or more of the following features
a. The declaration file may be formatted in YAML, JSON, or XML to support various user preferences and system compatibility requirements;
b. The data pipeline may be configured to handle both streaming and scheduled batch jobs, providing flexibility for real-time analytics and periodic data transformations.
c. The pipeline may process data from multiple heterogeneous sources, including files, APIs, and streaming endpoints, ensuring integration across diverse data ecosystems.
d. Data quality may be enforced during the conversion step by validating attributes such as data type, nullability, and unique constraints, ensuring compliance with declared rules.
e. A machine learning module, such as a large language model (LLM), may optimize pipeline configurations based on the declaration file and runtime metrics, improving efficiency and scalability.
f. Custom indexing functions, including row number transformations, may be specified in the configuration section to enable advanced data processing.
g. The system may provision and tune a cluster computing infrastructure based on metadata derived from the data source and declaration file, optimizing resource allocation.
h. Logical representations may include definitions to identify downstream impacts of data attribute changes, such as type conversions, ensuring adaptability and traceability.
i. The system may automatically push the generated data structure and metadata to a data catalog using a push architecture, enabling streamlined data discovery and governance.
j. The pipeline may include a data modeling step where an LLM generates transformation logic and field definitions, enhancing pipeline design and execution.
k. Fields designated as personally identifiable information (PII) may be masked automatically within the pipeline, ensuring compliance with privacy regulations before writing data to the target database.
l. A graphical user interface may enable users to configure pipelines interactively, including defining steps visually through drag-and-drop functionality.
m. Data governance operations may generate audit reports to validate compliance with data quality and usage policies, enhancing transparency and accountability.
n. Runtime logs and execution plans may be analyzed to suggest optimizations for subsequent pipeline executions, improving overall performance.
o. Merge statements may integrate new data sources into the pipeline, streamlining data updates and ensuring consistency.
p. The pipeline may handle schema evolution by automatically adapting to changes in field definitions, maintaining operational continuity.
q. A version control mechanism may optionally be implemented, allowing the pipeline to track schema changes via versioning, including assigning version numbers to fields.

Embodiments of the present invention enable a robust, flexible, and scalable framework for declarative data processing, governance, and transformation.

While the invention has been described with reference to the specific embodiments, it will be understood by those skilled in the art that various changes may be made without departing from the scope of the present specification. Furthermore, the scope of the present specification is not intended to be limited to the specific embodiments described herein. Additionally, the range of embodiments described herein is not intended to limit the scope of the present specification. Rather, the invention encompasses all modifications and variations within the scope of the present specification.

1. A method comprising the steps of:
at a server comprising a processor, a memory, and a network interface device connected to a network,
receiving a declaration file comprising:
a fields section defining a database table, including data attributes;
a configuration section defining data processing actions on the database table;
converting the declaration file into a set of intermediate representations to produce logical representations of a data pipeline, wherein the conversion enforces data quality rules;
generating, using the configuration section of the declaration file and the logical representation, a data pipeline comprising extracted, transformed, and loaded data from a data source into the database table;
deploying the data pipeline to a data processing platform for data ingestion;
receiving one or more jobs or workflows for execution against the generated data pipeline; and
executing the jobs or workflows.

2. The method of claim 1 wherein the YAML declaration file is in YAML, JSON, or XML format.

3. The method of claim 1, further comprising configuring the data pipeline to support both streaming and scheduled batch jobs.

4. The method of claim 1, wherein the data pipeline is generated to process data from multiple heterogeneous data sources.

5. The method of claim 1, wherein data quality is enforced at the conversion step by validating field attributes, including data type and nullability.

6. The method of claim 1, further comprising utilizing a machine learning module or LLM to optimize pipeline configuration based on the declaration file and runtime metrics.

7. The method of claim 1, wherein the configuration section includes a custom function for indexing, such as a row number transformation.

8. The method of claim 1, further comprising provisioning and tuning a cluster computing system based on data source metadata and the declaration file.

9. The method of claim 1, wherein the logical representations include definitions for identification of downstream impacts of data attribute changes, including type conversions.

10. The method of claim 1, further comprising pushing the generated data structure to a data catalog using a push architecture.

11. The method of claim 1, wherein the pipeline includes a data modeling step, comprising generating transformation logic and determining field definitions using a large language model (LLM).

12. The method of claim 1, further comprising defining a field as personally identifiable information (PII), and configuring the pipeline to mask PII data automatically before writing to a target database.

13. The method of claim 1, further comprising enabling a graphical user interface for pipeline configuration, wherein the interface allows users to visually define pipeline steps.

14. The method of claim 1, wherein the data governance operations include generating audit reports for data quality compliance.

15. The method of claim 1, further comprising analyzing runtime logs and execution plans to suggest optimizations for future pipeline execution.

16. The method of claim 1, further comprising applying merge statements for integrating new data sources into the pipeline.

17. The method of claim 1, wherein the pipeline is configured to handle schema evolution by automatically adapting to changes in field definitions.

18. The method of claim 17, wherein the generated data pipeline optionally includes a versioning mechanism to track revisions to field definitions over time.

19. A system for declarative data processing, comprising: a memory storing instructions for declarative data governance; and a processor configured to execute the instructions to:
receive a declaration file comprising:
a fields section defining a database table, including data attributes;
a configuration section defining data processing actions on the database table;
convert the declaration file into a set of intermediate representations to produce logical representations of a data pipeline, wherein the conversion enforces data quality rules;
generate, using the configuration section of the declaration file and the logical representation, a data pipeline comprising extracted, transformed, and loaded data from a data source into the database table;
deploy the data pipeline to a data processing platform for data ingestion;
receive one or more jobs or workflows for execution against the generated data pipeline; and
execute the jobs or workflows.

20. At least one non-transitory computer-readable storage medium storing instructions that, when executed by at least one processor, cause the at least one processor to:
receive a declaration file comprising:
a fields section defining a database table, including data attributes;
a configuration section defining data processing actions on the database table;
convert the declaration file into a set of intermediate representations to produce logical representations of a data pipeline, wherein the conversion enforces data quality rules;
generate, using the configuration section of the declaration file and the logical representation, a data pipeline comprising extracted, transformed, and loaded data from a data source into the database table;
deploy the data pipeline to a data processing platform for data ingestion;
receive one or more jobs or workflows for execution against the generated data pipeline; and
execute the jobs or workflows.
